(19) United States
(12) Patent Application Publication
(10) Pub. No.: US 2019/0385550 A1
(43) Pub. Date: Dec. 19, 2019

(54) SIGNAL PROCESSING METHOD AND DISPLAY APPARATUS

(71) Applicant: QINGDAO HISENSE ELECTRONICS CO., LTD., Qingdao (CN)

(72) Inventor: QINGHUA TIAN, QINGDAO (CN)

(21) Appl. No.: 16/279,873

(22) Filed: Feb. 19, 2019

Related U.S. Application Data
(63) Continuation of application No. PCT/CN2018/107750, filed on Sep. 26, 2018.

(30) Foreign Application Priority Data
Jun. 15, 2018 (CN) 201810623371.3

(51) Int. Cl. G09G 3/36; G09G 3/20

(52) U.S. Cl. CPC G09G 3/3648; G09G 2320/0219; G09G 2310/08; G09G 3/2003

(57) ABSTRACT

Provided are a signal processing method and a display apparatus, the processing method includes: generating, by a timing controller, a first driving signal and a second driving signal according to a received image signal; respectively transmitting, by the timing controller, the first driving signal to a first source driver and the second driving signal to a second source driver with a preset time interval; starting, by the first source driver, a first grayscale conversion process after a first duration after reception of the first driving signal; starting, by the second source driver, a second grayscale conversion process after the first duration after reception of the second driving signal. The processing method makes it possible to effectively suppress electromagnetic interference of a disturbance source without increasing the production cost of the electronic device or reducing the stability of the electronic device.

### CROSS-REFERENCE TO RELATED APPLICATION

The present application is a continuation of International Application No. PCT/CN2018/107750, filed on Sep. 26, 2018, which claims priority to Chinese Patent Application No. 201810623371.3, filed on Jun. 15, 2018 and entitled “Signal Transmission Method, Apparatus, Terminal, and Readable Storage Medium”. The disclosures of the aforementioned applications are incorporated by reference herein in their entireties.

### TECHNICAL FIELD

The present disclosure relates to computer technology, and in particular, to a signal processing method and a display apparatus.

### BACKGROUND

Electromagnetic interference is an electromagnetic phenomenon that causes performance degradation of electronic device. It is necessary to take measures to suppress or reduce the electromagnetic interference to ensure a normal operation of the electronic device. There are three elements that cause the electromagnetic interference, including a disturbance source, a coupling path and a sensitive device. Among them, it is necessary to take measures to suppress the disturbance source.

### SUMMARY

Some embodiments of the present disclosure provide a processing method for a driving signal of a display apparatus, where the display apparatus includes a timing controller (TCON), a first source driver and a second source driver; the processing method includes:

generating, by the timing controller, a first driving signal and a second driving signal according to a received image signal;

respectively transmitting, by the timing controller, the first driving signal to the first source driver and the second driving signal to the second source driver with a preset time interval;

starting, by the first source driver, a first grayscale conversion process after a first duration after reception of the first driving signal; and

starting, by the second source driver, a second grayscale conversion process after the first duration after reception of the second driving signal.

Some other embodiments of the present disclosure provide a display apparatus including a timing controller, a first source driver and a second source driver;

the timing controller is configured to: generate a first driving signal and a second driving signal according to a received image signal; and respectively transmit the first driving signal to the first source driver and the second driving signal to the second source driver with a preset time interval;

the first source driver is configured to start a first grayscale conversion process after a first duration after reception of the first driving signal; and

the second source driver is configured to start a second grayscale conversion process after the first duration after reception of the second driving signal.

On the basis of the present disclosure, it is obvious that more implementation scenarios can be obtained. It should be understood that numerous scenarios of the present disclosure may be implemented separately or in a combination of one or more embodiments. The description of the implementation scenario of the present disclosure is intended to provide a better understanding of the present disclosure instead of constructing a limitation of the present disclosure.

### BRIEF DESCRIPTION OF DRAWINGS

In order to more clearly explain the present disclosure or the technical solutions in the related art, the drawings required to be used in the description of the embodiments or the related art will be briefly described below. It is obvious that the drawings described below are some embodiments but not all of the feasible embodiments of the present disclosure. For those skilled in the art, other drawings may be obtained according to the drawings without any creative work.

FIGS. 1(a) and 1(b) are module architecture diagrams showing the signal processing of a display terminal;

FIG. 2 is a schematic diagram of controlling of startup timing signal of a source driver;

FIG. 3 is a schematic flowchart diagram of a processing method for a driving signal of a display apparatus according to some embodiments of the present disclosure;

FIG. 4 is a schematic diagram of a signal transmission in the related art;

FIG. 5 is a schematic diagram of a signal transmission in some embodiments of the present disclosure;

FIG. 6 is a schematic flowchart diagram of a processing method for a driving signal of a display apparatus according to some other embodiments of the present disclosure;

FIG. 7 is a module architecture diagram of a timing controller in a display apparatus according to some embodiments of the present disclosure;

FIG. 8 is a module architecture diagram of a timing controller in a display apparatus according to some other embodiments of the present disclosure.

### DESCRIPTION OF EMBODIMENTS

In order to make the objects, technical solutions and advantages of the present disclosure more clear, the technical solutions in the embodiments of the present disclosure will be clearly and completely described below in conjunction with the accompanying drawings in the embodiments of the present disclosure. It is obvious that the described embodiments are part of, but not all, the embodiments of the present disclosure. Based on the embodiments of the present disclosure, all other embodiments obtained by those skilled in the art without making creative work shall fall within the protection scope of the present disclosure.

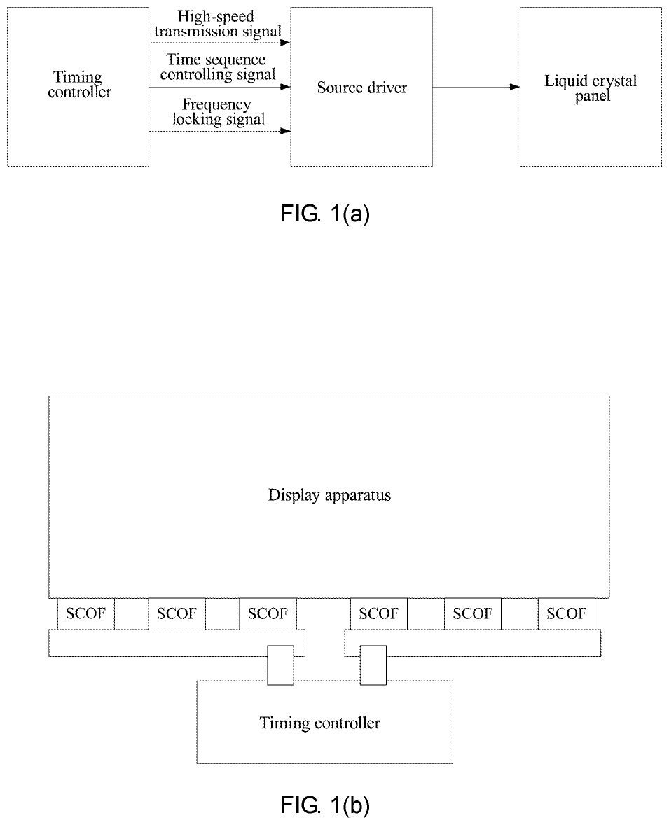

FIGS. 1(a) and 1(b) are module architecture diagrams showing the signal processing of a display terminal. As shown in FIG. 1(a), modules involved in a signal processing performed by the display terminal include a liquid crystal display panel, and include a timing controller and a source driver. The timing controller is a signal generating terminal, and is configured to generate and output driving signals such as a high data rate (HDR) signal, a timing controlling signal and a locking signal according to a received image signal. The source driver is configured to receive the driving signals from the timing controller, perform a processing such as a conversion for convert image data to grayscale data of the HDR signal in the received driving signals, and drive a corresponding display region in the display panel for display. As shown in FIG. 1(b), the display terminal includes at least two source drivers, the at least two source drivers respectively provide driving signals for at least two display regions of the display panel.

In some embodiments, the number of the source drivers may be 12. The 12 source drivers receive driving signals from the timing controller, respectively. It should be noted that the timing controller continuously generates driving signals to be transmitted and sent to each source driver in parallel, and the driving signals received by different source drivers are different.

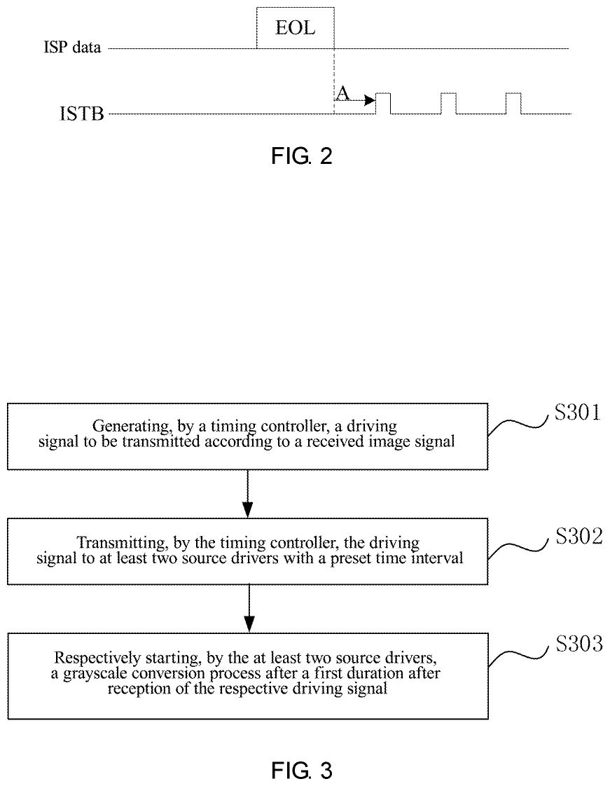

FIG. 2 is a schematic diagram of controlling of startup timing of the source driver. As shown in FIG. 2, ISP data is a kind of HDR signal, EOL is a bit of the ISP data indicates a cutoff of the ISP data, ISTB is a timing controlling signal of the source driver, and A is a time interval from a rising edge of a preset pulse of the ISTB signal to the EOL, the preset pulse is configured to control a startup time of a corresponding source driver, where the startup time is a time to start conversion for convert image data to grayscale data.

In the related art, in order to realize simultaneous driving of different columns of pixels, each source driver is set to start the conversion operation of the driving signal after a same predetermined time after receiving the data signal, such as, an EOL bit in the data signal may be taken as an identifier for receiving the data signal, the predetermined time may be a predetermined time interval A, and A corresponding to each source driver is the same. After the timing controller transmits the driving signal, at least two source drivers, configuring to drive data in different rows, start the conversion operation for convert image data to grayscale data simultaneously, and drive the corresponding display region in the display panel in parallel, where pixels in the display panel receives and displays the data in rows.

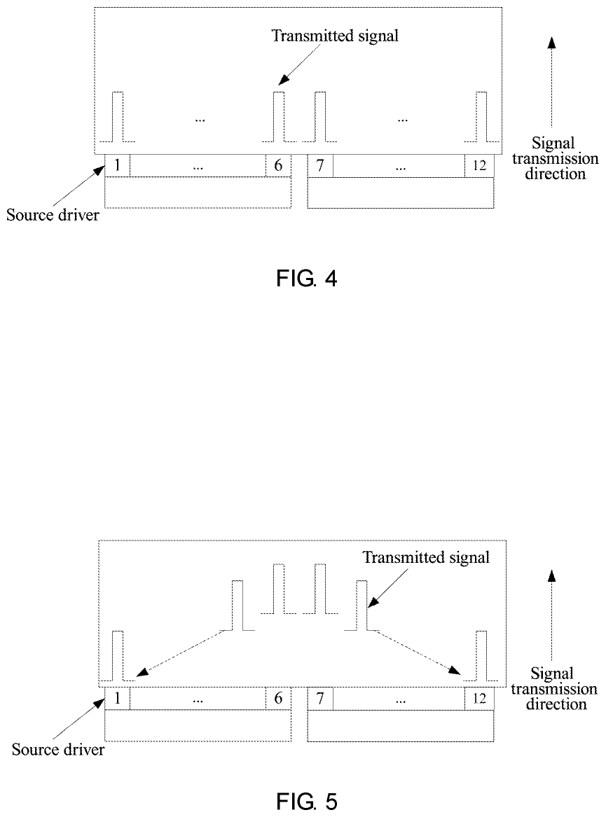

FIG. 4 is a schematic diagram of a signal transmission in the related art. As shown in FIG. 4, the display terminal includes 12 source drivers, and each source driver simultaneously starts a grayscale conversion operation to drive a corresponding display region in the display panel, such that the display panel displays the data.

Since at least two source drivers simultaneously start the grayscale conversion operation, an instantaneous energy of the source drivers, which act as the disturbance source, becomes large, and a transient energy of the radiation source may exceeds a standard, and thereby causing strong electromagnetic interference.

In the related art, the disturbance source may be suppressed based on physical characteristics, for example, a shield member is added in the electronic device to suppress the disturbance source. Alternatively, the disturbance source may be suppressed by weakening a processing ability of the disturbance source.

However, if a method based on physical characteristics is employed, the production cost of the electronic device is increased, and if a method for weakening the processing ability of the disturbance source is employed, the stability of the electronic device is lowered.

The present disclosure provides a signal processing method, a display apparatus and terminal. The timing controller generates a driving signal to be transmitted, and transmits the driving signal to at least two source drivers according to a preset time interval, thereby avoiding the problem of excessive radiation interference caused due to that at least two source drivers simultaneously start the grayscale conversion operation, thereby effectively suppressing electromagnetic interference of the disturbance source without increasing the production cost of the electronic device or reducing the stability of the electronic device.

It should be noted that the method described in the present disclosure is applicable to the display terminal such as a television. For ease of understanding, the following embodiments of the present disclosure take the module architecture described in FIG. 1 as an example to illustrate the technical solution of the present disclosure, but it is obvious that this is not a limitation of the disclosure, and the method described in the present disclosure can also be applied to the display terminal with other architectures as the module architecture.

FIG. 3 is a schematic flowchart diagram of a processing method for a driving signal of a display apparatus according to some embodiments of the present disclosure. The execution body of the method is a display terminal which includes a display apparatus including a timing controller, a first source driver and a second source driver. In some embodiments, the execution body of the method may be a module that generates a signal and controls a signal sequence, such as the timing controller in above FIG. 1. As shown in FIG. 3, the method includes:

S301: generating, by the timing controller, a driving signal to be transmitted according to a received image signal.

Taking the module architecture shown in above FIG. 1 as an example, the timing controller is used as a signal generating terminal to generate the driving signal to be transmitted.

S302: transmitting, by the timing controller, the driving signal to at least two source drivers with a preset time interval.

S303: respectively starting, by the at least two source drivers, a grayscale conversion process after a first duration after reception of the respective driving signal.

The grayscale conversion process is a conversion operation from image data to grayscale data.

In some embodiments, durations of the grayscale conversion processes in the at least two source drivers are the same, such that startup times for the at least two source drivers to drive the corresponding display regions are staggered.

After generating the driving signal to be transmitted according to the received image signal, the timing controller respectively transmits the driving signal to the at least two source drivers with a preset time interval, and the at least two source drivers drive the corresponding regions in the display apparatus in an order in which the driving signals are received after the respective grayscale conversion process.

For example, in some embodiments, the timing controller respectively transmitting the driving signal to the at least two source drivers with a preset time interval can be that the timing controller transmitting a first driving signal to a first source driver in a first second, and transmitting a second driving signal to a second source driver in a second second (in this case, the time interval is 1 second), and so on. After such processing, each source driver receives the driving signal at different time, and because the durations of the grayscale conversion processes in the at least two source drivers are the same, the startup times for driving the corresponding display regions are different. That is, the startup times for the source drivers to drive the corresponding display regions may be staggered. In some embodiments, the preset time interval may be set according to the requirements of the liquid crystal panel, and is not limited by the above examples.

In some other embodiments, as shown in FIG. 5, which is a schematic diagram of a signal transmission in some embodiments of the present disclosure. The intermediate source driver receives the driving signal at first, and then the source drivers in both sides of the intermediate source driver receive the driving signal successively. Each source driver starts the grayscale conversion process after the first duration after reception of the respective driving signal, and then drives the corresponding display region in the display apparatus to make the display apparatus to display data.

For example, in some embodiments, the display apparatus includes a first source driver, a second source driver, a third source driver and a fourth source driver. Durations of the grayscale conversion processes in the first source driver, the second source driver, the third source driver and the fourth source driver are the same.

The timing controller generates a first driving signal, a second driving signal, a third driving signal and a fourth driving signal according to the received image signal.

In some embodiments, the timing controller respectively transmits the first driving signal to the first source driver, transmits the second driving signal to the second source driver, transmits the third driving signal to the third source driver and transmits the fourth driving signal to the fourth source driver with a preset time interval, where there is the preset time interval between the first driving signal and the second driving signal, the second driving signal and the third driving signal, the third driving signal and the fourth driving signal.

In some embodiments, a moment for the transmitting the third driving signal to the third source driver is the same as a moment for transmitting the first driving signal to the first source driver, and a moment for the transmitting the fourth driving signal to the fourth source driver is the same as a moment for transmitting the second driving signal to the second source driver; where there is the preset time interval between the moment for transmitting the first driving signal to first source driver and the moment for transmitting the second driving signal to the second source driver.

The first source driver and the third source driver are symmetrically arranged along a vertical symmetry axis of the display apparatus, and the second source driver and the fourth source driver are symmetrically arranged along the vertical symmetry axis of the display apparatus. Where the vertical symmetry axis is along a vertical direction.

A distance between the first source driver and the vertical symmetry axis is smaller than a distance between the second source driver and the vertical symmetry axis, and the moment for the transmitting the first driving signal to the first source driver is earlier than the moment for transmitting the second driving signal to the second source driver.

In some embodiments of the present disclosure, the timing controller generates the driving signal to be transmitted and transmits the driving signal to the at least two source drivers with the preset time interval, such that the at least two source drivers, which act as the disturbance source, respectively start the grayscale conversion process after the first duration after reception of the respective driving signal, thereby avoiding the problem of excessive radiation interference caused due to that the at least two source drivers simultaneously start the conversion operation, thereby effectively suppressing electromagnetic interference of the disturbance source without increasing the production cost of the electronic device or reducing the stability of the electronic device.

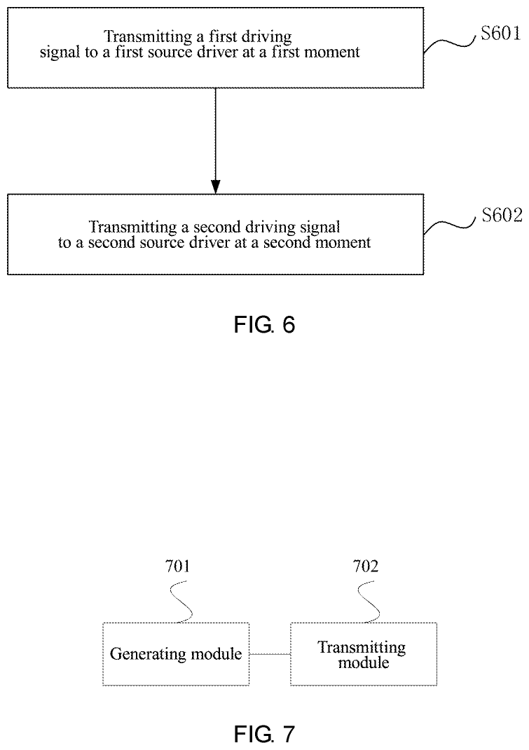

In some other embodiments, as shown in FIG. 6, which is a schematic flowchart diagram of a processing method for a driving signal of a display apparatus according to some other embodiments of the present disclosure. Step S302 includes:

S601: transmitting the first driving signal to the first source driver at a first moment; and

S602: transmitting the second driving signal to the second source driver at a second moment.

The second moment is a moment after the first moment, and there is a preset time interval between the first moment and the second moment.

The above step S303 includes:

starting, by the first source driver, a first grayscale conversion process after the first duration after reception of the first driving signal;

starting, by the second source driver, a second grayscale conversion process after the first duration after reception of the second driving signal.

In some embodiments, in order to achieve a simultaneous data display on each region of the liquid crystal display panel, a duration of the first grayscale conversion process in the first source driver is longer than a duration of the second grayscale conversion process in the second source driver, and a difference between the duration of the first grayscale conversion process in the first source driver and the duration of the second grayscale conversion process in the second source driver is substantially equal to the preset time interval, so that the first source driver and the second source driver may simultaneously drive corresponding display regions in the display apparatus to make the display apparatus to display data. That is, a time taken for the grayscale conversion of the source driver that starts the grayscale conversion earlier is longer than a time taken for the grayscale conversion of the source driver that starts the grayscale conversion later, so that all the source drivers simultaneously end the grayscale conversion process, and the data display is simultaneously performed on each region of the liquid crystal display panel. The moment at which the source driver starts the grayscale conversion is set to be after the first duration after receiving the driving signal, and is controlled by a level rising edge of the ISTB signal, and the moment at which the grayscale conversion operation finished may be controlled by a level descending edge of the ISTB signal. In some embodiments, there is a delay for the first source driver to output the converted grayscale data, the delay is substantially equal to the preset time interval.

In some embodiments, the display apparatus further includes a liquid crystal cell matrix;

The processing method further includes outputting, by the at least two source drivers, a grayscale voltage to the liquid crystal cell matrix after the grayscale conversion process finished, where the grayscale voltage corresponds to the converted grayscale data corresponds to the driving signal.

In some embodiments, the timing controller transmits the driving signal to the at least two source drivers with the preset time interval, so that the timing controller transmits the driving signal to the at least two source drivers at a preset transmission timing set with the preset time interval. There is a preset corresponding relationship between the preset transmission timing and identifiers of the at least two source drivers.

In some embodiments, the corresponding relationship between the transmission timing and the identifiers of the source drivers may be established in advance.

In some embodiments, the identifier of the source driver may be a serial number of the source driver.

In some embodiments, it is assumed that there are 12 source drivers in the display terminal, the corresponding relationship between the transmission timing and the identifiers of the source drivers as shown in Table 1 below may be established in advance.

TABLE 1

| | Identifier of the |
|---|---|
| Transmission Timing | source driver |
| 1st millisecond | 6, 7 |
| 2nd millisecond | 5, 8 |
| 3rd millisecond | 4, 9 |
| 4th millisecond | 3, 10 |
| 5th millisecond | 2, 11 |
| 6th millisecond | 1, 12 |

That is, the timing controller will transmit the driving signal to the sixth and seventh source drivers in the 1st millisecond, and transmit the driving signal to the fifth and eighth source drivers in the second millisecond, and so on. The time interval is 1 millisecond between the adjacent transmission timing.

Based on the above embodiments, some embodiments of the present disclosure relate to a specific process of transmitting the driving signal.

In some embodiments, the at least two source drivers may be divided into multiple driver groups. The third source driver in a first driver group and the ninth source driver in the second driver group are symmetrically disposed about a vertical center axis of the display panel along the vertical direction.

In some embodiments, the first source driver and the second source driver are two source drivers within the same driver group.

In some embodiments, the at least two source drivers may be divided into two driver groups.

It is assumed that there are 12 source drivers in the display terminal, where the source drivers numbered with 1 to 6 belong to driver group 1, and the source drivers numbered with 7 to 12 belong to driver group 2. Then in some embodiments, the following methods may be used for signal transmission:

In some embodiments, the driving signal is transmitted to the first source driver and the seventh source driver in the first millisecond, to the second source driver and the eighth source driver in the second millisecond, to the third source driver and the ninth source driver in the third millisecond, and so on according to a first direction in each group.

In some other embodiments, the driving signal is transmitted to the sixth source driver and the twelfth source driver in the first millisecond, to the fifth source driver and the eleventh source driver in the second millisecond, to the fourth source driver and the tenth source driver in the third millisecond, and so on according to a second direction in each group.

In still some other embodiments, the driving signal is transmitted to the sixth source driver and the seventh source driver in the first millisecond, to the fifth source driver and the eighth source driver in the second millisecond, to the fourth source driver and the ninth source driver in the third millisecond, and so on according to a direction away from the symmetry axis in each group.

The present disclosure further provides a display apparatus including a timing controller and at least two source drivers. FIG. 7 is a module architecture diagram of a timing controller in a display apparatus according to some embodiments of the present disclosure. As shown in FIG. 7, the timing controller includes:

a generating module 701, configured to generate a driving signal to be transmitted according to a received image signal; and

a transmitting module 702, configured to transmit the driving signal to the at least two the source drivers with a preset time interval.

The at least two source drivers respectively start a grayscale conversion process after a first duration after reception of the respective driving signal, where the grayscale conversion process is a conversion operation from image data to grayscale data.

In some embodiments, durations of the grayscale conversion processes in the at least two source drivers are the same, such that startup times for the at least two source drivers to drive the corresponding display regions are staggered. In some embodiments, durations of receiving the driving signal by the at least two source drivers are substantially the same.

After generating the driving signal to be transmitted according to the received image signal, the generating module 701 respectively transmits the driving signal to the at least two source drivers with the preset time interval. In some embodiments, the at least two source drivers drive the corresponding regions in the display apparatus in an order in which the driving signals are received after the respective grayscale conversion process.

For example, in some embodiments, the transmitting module 702 respectively transmitting the driving signal to the at least two source drivers with the preset time interval can be that the transmitting module 702 transmitting a first driving signal to a first source driver in a first second, and transmitting a second driving signal to a second source driver in a second second, transmitting a third driving signal to a third source driver in a third second, and transmitting a fourth driving signal to a fourth source driver in a fourth second, and so on. Where there is a same preset time interval between the first second and the second second, and between the second second and the third second, and between the fourth second and the third second. After such processing, each source driver receives the driving signal at different time, and because the durations of the grayscale conversion processes in the at least two source drivers are the same, the startup times for driving the corresponding display regions are different. That is, the startup times for the source drivers to drive the corresponding display regions may be staggered. In some embodiments, the preset time interval may be set according to the requirements of the liquid crystal panel, and is not limited by the above examples.

In some other embodiments, as shown in FIG. 5, the intermediate source driver first receives the driving signal, and then the source drivers in both sides of the intermediate source driver receive the driving signal in turn. Each source driver starts the grayscale conversion process after the first duration after reception of the respective driving signal, and then drives the corresponding display region in the display apparatus to make the display apparatus to display data.

For example, in some embodiments, the display apparatus includes a first source driver, a second source driver, a third source driver, and a fourth source driver. Durations of the grayscale conversion processes in the first source driver, the second source driver, the third source driver and the fourth source driver are the same.

The generating module 701 generates a first driving signal, a second driving signal, a third driving signal and a fourth driving signal according to the received image signal.

The transmitting module 702 respectively transmits the first driving signal to the first source driver with the preset time interval, the second driving signal to the second source driver with the preset time interval, the third driving signal to the third source driver with the preset time interval, and the fourth driving signal to the fourth source driver with the preset time interval, where there is the preset time interval between any two of the first driving signal, the second driving signal, the third driving signal and the fourth driving signal.

A moment for the transmitting the third driving signal to the third source driver is the same as a moment for transmitting the first driving signal to the first source driver, and a moment for the transmitting the fourth driving signal to the fourth source driver is the same as a moment for transmitting the second driving signal to the second source driver; where there is the preset time interval between the moment for transmitting the first driving signal to first source driver and the moment for transmitting the second driving signal to the second source driver.

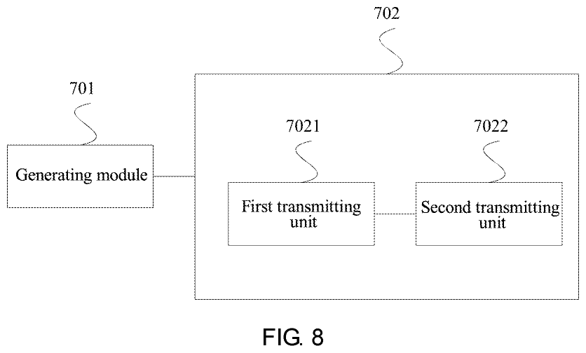

In other embodiments, as shown in FIG. 8, FIG. 8 is a module architecture diagram of a timing controller in a display apparatus according to some other embodiments of the present disclosure. The transmitting module 702 includes:

a first transmitting unit 7021, configured to transmit the first driving signal to the first source driver at a first moment;

a second transmitting unit 7022, configured to transmit the second driving signal to the second source driver at a second moment.

The second moment is a moment after the first moment, and there is a preset time interval between the first moment and the second moment.

The at least two source drivers respectively starting a grayscale conversion process after a first duration after reception of the respective driving signal including:

the first source driver starts a first grayscale conversion process after the first duration after reception of the first driving signal;

the second source driver starts a second grayscale conversion process after the first duration after reception of the second driving signal.

In some embodiments, a duration of the first grayscale conversion process in the first source driver is longer than a duration of the second grayscale conversion process in the second source driver, and a difference between the duration of the first grayscale conversion process in the first source driver and the duration of the second grayscale conversion process in the second source driver is substantially equal to the preset time interval, so that the first source driver and the second source driver may simultaneously drive corresponding display regions in the display apparatus to make the display apparatus to display data.

In some embodiments, the display apparatus further includes a liquid crystal cell matrix;

The at least two source drivers output a grayscale voltage to the liquid crystal cell matrix after the grayscale conversion process finished, where the grayscale voltage corresponds to the driving signal.

In other embodiments, the transmitting module 702 transmits the driving signal to the at least two source drivers with the preset time interval, so that the transmitting module 702 transmits the driving signal to the at least two source drivers at a preset transmission timing set with the preset time interval. There is a preset corresponding relationship between the preset transmission timing and identifiers of the at least two source drivers.

In some embodiments, the corresponding relationship between the transmission timing and the identifiers of the source drivers may be established in advance.

In some embodiments, the identifier of the source driver may be a serial number of the source driver.

In some embodiments, it is assumed that there are 12 source drivers in the display terminal, the corresponding relationship between the transmission timing and the identifiers of the source drivers as shown in Table 1 above may be established in advance.

That is, the transmitting module 702 will transmit the driving signal to the sixth and seventh source drivers in the 1st millisecond, and transmit the driving signal to the fifth and eighth source drivers in the second millisecond, and so on. The time interval is 1 millisecond between the adjacent transmission timing.

In other embodiments, the at least two of the source drivers constitute multiple driver groups, the first source driver and the second source driver are source drivers within the same driver group.

Some embodiments of the present disclosure further provide a terminal including a display apparatus, which includes the timing controller described above and at least two source drivers.

It will be understood by those skilled in the art that all or part of the steps for implementing the above method embodiments may be performed by hardware related to program instructions. The aforementioned program may be stored in a computer readable storage medium. The program, when executed, performs the steps including the above described method embodiments; and the above storage medium includes various medium that can store program codes, such as a ROM, a RAM, a magnetic disk, or an optical disk.

Finally, it should be noted that the above embodiments are merely illustrative of the technical solutions of the present disclosure, and are not intended to be limiting; although the present disclosure has been described in detail with reference to the above embodiments, those skilled in the art will understand that the technical solutions described in the above embodiments may be modified, or some or all of the technical features may be equivalently substituted; and the modifications or substitutions do not deviate the essence of the corresponding technical solution from the scope of the technical solution of each embodiment of the present disclosure.

What is claimed is:

1. A processing method for a driving signal of a display apparatus, wherein the display apparatus comprises a timing controller, a first source driver and a second source driver; the processing method comprises:
generating, by the timing controller, a first driving signal and a second driving signal according to a received image signal;
respectively transmitting, by the timing controller, the first driving signal to the first source driver and the second driving signal to the second source driver with a preset time interval;
starting, by the first source driver, a first grayscale conversion process after a first duration after reception of the first driving signal;
starting, by the second source driver, a second grayscale conversion process after the first duration after reception of the second driving signal.

2. The processing method according to claim 1, wherein a duration of the first grayscale conversion process in the first source driver is the same as a duration of the second grayscale conversion process in the second source driver.

3. The processing method according to claim 1, wherein a moment for transmitting the first driving signal to the first source driver is earlier than a moment for transmitting the second driving signal to the second source driver; a duration of the first grayscale conversion process in the first source driver is longer than a duration of the second grayscale conversion process in the second source driver; the difference between the duration of the first grayscale conversion process in the first source driver and the duration of the second grayscale conversion process in the second source driver is substantially equal to the preset time interval.

4. The processing method according to claim 1, wherein the display apparatus further comprises a liquid crystal cell matrix;
the processing method further comprises:
outputting, by the first source driver, a first grayscale voltage to the liquid crystal cell matrix after the first grayscale conversion process finished, wherein the first grayscale voltage corresponds to the first driving signal; and
outputting, by the second source driver, a second grayscale voltage to the liquid crystal cell matrix after the second grayscale conversion process finished, wherein the second grayscale voltage corresponds to the second driving signal.

5. The processing method according to claim 1, wherein the display apparatus further comprises a third source driver and a fourth source driver, the timing controller is further configured to generate a third driving signal and a fourth driving signal according to the received image signal;
the timing controller respectively transmits the third driving signal to the third source driver and the fourth driving signal to the fourth source driver with the preset time interval;
a moment for the transmitting the third driving signal to the third source driver is the same as a moment for transmitting the first driving signal to the first source driver, and a moment for the transmitting the fourth driving signal to the fourth source driver is the same as a moment for transmitting the second driving signal to the second source driver.

6. The processing method according to claim 5, wherein the first source driver and the third source driver are symmetrically arranged along a vertical symmetry axis of the display apparatus, and the second source driver and the fourth source driver are symmetrically arranged along the vertical symmetry axis.

7. The processing method according to claim 6, wherein a distance between the first source driver and the vertical symmetry axis is smaller than a distance between the second source driver and the vertical symmetry axis, and the moment for the transmitting the first driving signal to the first source driver is earlier than the moment for transmitting the second driving signal to the second source driver.

8. A display apparatus, comprising: a timing controller, a first source driver and a second source driver;
the timing controller is configured to: generate a first driving signal and a second driving signal according to a received image signal; and respectively transmit the first driving signal to the first source driver and the second driving signal to the second source driver with a preset time interval;
the first source driver is configured to start a first grayscale conversion process after a first duration after reception of the first driving signal;
the second source driver is configured to start a second grayscale conversion process after the first duration after reception of the second driving signal.

9. The display apparatus according to claim 8, wherein a duration of the first grayscale conversion process in the first source driver is the same as a duration of the second grayscale conversion process in the second source driver.

10. The display apparatus according to claim 8, wherein a moment for the timing controller to transmit the first driving signal to the first source driver is earlier than a moment for the timing controller to transmit the second driving signal to the second source driver; a duration of the first grayscale conversion process in the first source driver is longer than a duration of the second grayscale conversion process in the second source driver; the difference between the duration of the first grayscale conversion process in a source driver and the duration of the second grayscale conversion process in the second source driver is substantially equal to the preset time interval.

11. The display apparatus according to claim 8, further comprising a liquid crystal cell matrix;
the first source driver outputs a first grayscale voltage to the liquid crystal cell matrix after the first grayscale conversion process finished, wherein the first grayscale voltage corresponds to the first driving signal; and
the second source driver outputs a second grayscale voltage to the liquid crystal cell matrix after the second grayscale conversion process finished, wherein the second grayscale voltage corresponds to the second driving signal.

12. The display apparatus according to claim 8, further comprising a third source driver and a fourth source driver, the timing controller is further configured to generate a third driving signal and a fourth driving signal according to the received image signal, and respectively transmit the third driving signal to the third source driver and the fourth driving signal to the fourth source driver with the preset time interval;
a moment for the timing controller to transmit the third driving signal to the third source driver is the same as a moment for the timing controller to transmit the first driving signal to the first source driver, and a moment for the timing controller to transmit the fourth driving signal to the fourth source driver is the same as a moment for the timing controller to transmits the second driving signal to the second source driver.

13. The display apparatus according to claim 12, wherein the first source driver and the third source driver are symmetrically arranged along a vertical symmetry axis of the display apparatus, and the second source driver and the fourth source driver are symmetrically arranged along the vertical symmetry axis.

14. The display apparatus according to claim 13, wherein a distance between the first source driver and the vertical symmetry axis is smaller than a distance between the second source driver and the vertical symmetry axis, and the moment for the timing controller to transmit driving signal to the first source driver is earlier than the moment for the timing controller to transmit the second driving signal to the second source driver.
